(19) United States
(12) Patent Application Publication
(10) Pub. No.: US 2019/0178581 A1
(43) Pub. Date: Jun. 13, 2019

(54) NOISE REDUCTION-TYPE DOUBLE-PIPE HEAT EXCHANGER

(71) Applicant: HS R & A Co., Ltd., Gyeongsangnam-do (KR)

(72) Inventors: Jae Hyeok CHOI, Gyeongsangnam-do (KR); Deok Hyun LIM, Gyeongsangnam-do (KR); Young Jun KIM, Gyeongsangnam-do (KR)

(21) Appl. No.: 16/191,701

(22) Filed: Nov. 15, 2018

(30) Foreign Application Priority Data
Dec. 8, 2017 (KR) 10-2017-0168281

(51) Int. Cl. F28D 7/10; F25B 41/06; F28F 1/02

(52) U.S. Cl. CPC F28D 7/106; F25B 41/062; F16L 9/20; F25B 2500/12; F28F 1/022

(57) ABSTRACT

Disclosed is a noise reduction-type double-pipe heat exchanger including: a first pipe through which a low-temperature fluid flows; an enlarged pipe portion connected to the first pipe, the diameter of the enlarged pipe portion being larger than the diameter of the first pipe; a second pipe connected to the enlarged pipe portion, the low-temperature fluid flowing through the second pipe; and a third pipe formed separately from the first pipe and the second pipe, a high-temperature fluid flowing through the third pipe, the diameter of the third pipe being smaller than the diameter of the first pipe, the third pipe penetrating a surface of the enlarged pipe portion and extending into the first pipe through an inner portion of the enlarged pipe portion. Other embodiments are also possible.

### CROSS-REFERENCE TO RELATED APPLICATION(S)

This application is based on and claims priority under 35 U.S.C. § 119 to Korean Patent Application No. 10-2017-0168281, filed on Dec. 8, 2017, in the Korean Intellectual Property Office, the disclosure of which is incorporated by reference herein in its entirety.

### BACKGROUND

### 1) Field

The present disclosure relates to a heat-exchanging double pipe and a silencer for fluid noise reduction and, more particularly, to a heat-exchanging double pipe which provides a double-pipe structure having excellent performance in terms of heat conductivity, and which can reduce noise generated by a fluid flowing inside the double pipe.

### 2) Description of Related Art

The above information is presented as background information only to assist with an understanding of the present disclosure. No determination has been made, and no assertion is made, as to whether any of the above might be applicable as prior art with regard to the present disclosure.

Heat exchange between low and high temperatures is required in various fields, and a device such as a heat exchanger may be used to exchange heat between a high-temperature fluid and a low-temperature fluid.

However, pulsation noise may occur in a pipe along which a fluid flows, and there has been an ongoing research/development for reducing such noise.

### SUMMARY

An aspect of the present disclosure is to provide a double-pipe heat exchanger which has a double-pipe structure so as to improve the heat exchange efficiency of the heat exchanger, thereby improving the cooling efficiency of the cooling system, and which can reduce noise generated by the fluid circulating inside the double pipe.

A noise reduction-type double-pipe heat exchanger according to an embodiment of the present disclosure may include: a first pipe through which a low-temperature fluid flows; an enlarged pipe portion connected to the first pipe, the diameter of the enlarged pipe portion being larger than the diameter of the first pipe; a second pipe connected to the enlarged pipe portion, the low-temperature fluid flowing through the second pipe; and a third pipe formed separately from the first pipe and the second pipe, a high-temperature fluid flowing through the third pipe, the diameter of the third pipe being smaller than the diameter of the first pipe, the third pipe penetrating a surface of the enlarged pipe portion and extending into the first pipe through an inner portion of the enlarged pipe portion.

The noise reduction-type double-pipe heat exchanger according to the present disclosure is advantageous in that the same has a double-pipe structure so as to improve the heat exchange efficiency of the heat exchanger, thereby improving the cooling efficiency of the cooling system, and can also play the role of a silencer that counterbalances noise generated by the fluid circulating inside the double pipe.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram for illustrating the concept of heat exchange in a noise reduction-type double-pipe heat exchanger according to an embodiment of the present disclosure;

FIG. 2 is a perspective view illustrating the internal structure of a noise reduction-type double-pipe heat exchanger according to an embodiment of the present disclosure;

FIG. 3 is a sectional view illustrating the internal structure of a noise reduction-type double-pipe heat exchanger according to an embodiment of the present disclosure;

FIG. 4 is a perspective view illustrating the internal structure of a noise reduction-type double-pipe heat exchanger according to another embodiment of the present disclosure; and

FIG. 5 is a sectional view illustrating the internal structure of a noise reduction-type double-pipe heat exchanger according to another embodiment of the present disclosure.

### DETAILED DESCRIPTION

Hereinafter, various embodiments of this document will be described with reference to the accompanying drawings. However, it should be understood that technology described in this document is not limited to a specific embodiment and includes various modifications, equivalents, and/or alternatives of an embodiment of this document. The same reference numbers are used throughout the drawings to refer to the same or like parts. In this document, an expression such as “A or B,” “at least one of A or/and B,” or “one or more of A or/and B” may include all possible combinations of together listed items. An expression such as “first” and “second” used in this document may indicate various constituent elements regardless of order and/or importance, is used for distinguishing a constituent element from another constituent element, and does not limit corresponding constituent elements. When it is described that a constituent element (e.g., a first constituent element) is “(operatively or communicatively) coupled with/to” or is “connected to” another constituent element (e.g., a second constituent element), it should be understood that the constituent element may be directly connected to the another constituent element or may be connected to the another constituent element through another constituent element (e.g., a third constituent element).

An expression “configured to” used in this document may be interchangeably used with, for example, “suitable for,” “having the capacity to,” “designed to,” “adapted to,” “made to,” or “capable of” according to a situation.

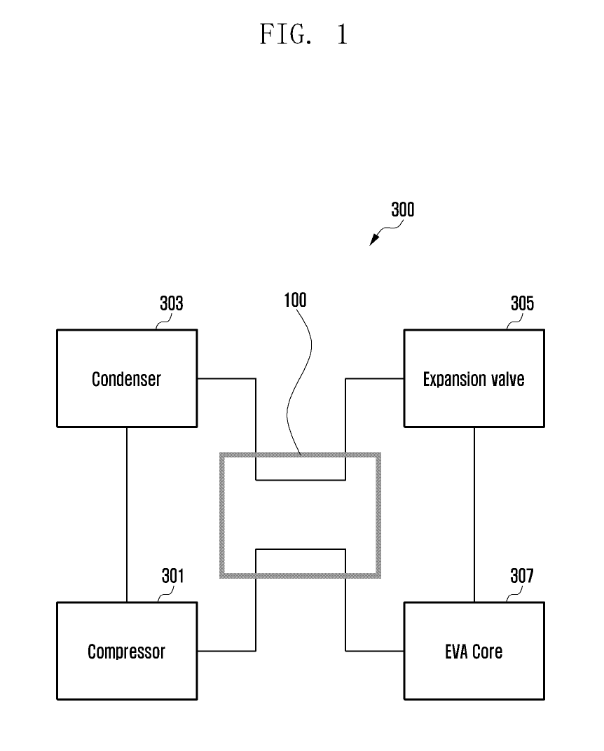

FIG. 1 is a block diagram for illustrating the concept of heat exchange in a noise reduction-type double-pipe heat exchanger according to an embodiment of the present disclosure.

A noise reduction-type double-pipe heat exchanger according to an embodiment of the present disclosure may be used for a refrigerant circulation path 300 for cooling air-conditioning, for example. In the case of a cooling system for cooling air-conditioning, a refrigerant may generally circulate through a compressor 301, a condenser 303, an expansion valve 305, and an evaporator core 307. The refrigerant may undergo the following process: the refrigerant passes through the compressor 301 and reaches a high-temperature high-pressure state; the refrigerant passes through the condenser 303, undergoes a temperature drop, and reaches a mainly liquid state; after passing through the condenser 303, the refrigerant passes through the expansion valve 305 and undergoes a rapid expansion; the refrigerant then reaches a low-temperature low-pressure state and reaches a mainly gas state; and the refrigerant passes through the evaporator core 307, absorbs ambient heat, and is re-supplied to the compressor 301.

When the low-temperature refrigerant in a gas state is supplied to the compressor 301, the compressor 301 operates and supplies energy thereto. The refrigerant again switches to a high-temperature high-pressure state, and a large amount of energy is consumed in this regard.

The refrigerant needs to reach as low a temperature as possible before being supplied to the expansion valve 305 such that, when supplied to the evaporator core 307 later, the refrigerant has a sufficiently low temperature to absorb a large amount of energy. Therefore, a large amount of energy is wasted as the refrigerant passes through the condenser 303.

The large amount of energy wasted in the process of supplying the refrigerant from the condenser 303 to the expansion valve 305 may be supplied to the refrigerant introduced into the compressor 301 via the evaporator core 307 so as to partially raise the temperature of the refrigerant. This may reduce the net amount of energy needed by the compressor 301 to make a high-temperature high-pressure refrigerant, thereby improving the operating efficiency of the cooling cycle.

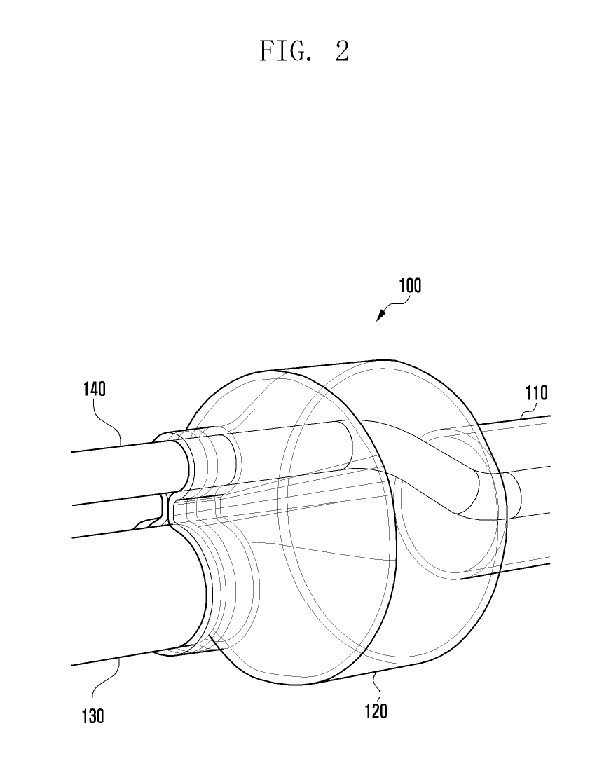

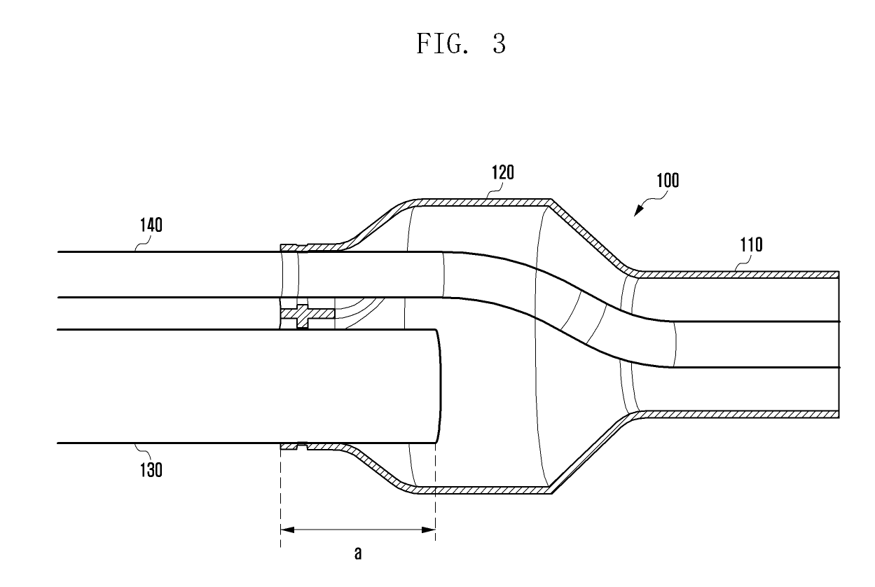

FIG. 2 is a perspective view illustrating the internal structure of a noise reduction-type double-pipe heat exchanger 100 according to an embodiment of the present disclosure. FIG. 3 is a sectional view illustrating the internal structure of the noise reduction-type double-pipe heat exchanger 100 according to an embodiment of the present disclosure.

Referring to FIG. 2 and FIG. 3, the noise reduction-type double-pipe heat exchanger 100 according to an embodiment of the present disclosure may include a first pipe 110, an enlarged pipe portion 120, a second pipe 130, and a third pipe 140.

Referring to FIG. 3, a gas-state refrigerant that has passed through an evaporator core may flow through the first pipe 110, the enlarged pipe portion 120, and the second pipe 130. The first pipe 110 may guide the refrigerant that has passed through the evaporator core to the enlarged pipe portion 120. The enlarged pipe portion 120 is formed to have a diameter larger than that of the first pipe portion 110, and may change the velocity of the refrigerant flowing inside the first pipe 110, the pressure thereof, and the like. The second pipe 130 may guide the refrigerant that has passed through the enlarged pipe portion 120 to be supplied to the compressor.

The third pipe 140 is configured to supply the refrigerant that has passed through the condenser to the expansion valve, and may deliver energy to the refrigerant guided to the compressor. The third pipe 140 is formed to have a diameter smaller than that of the first pipe 110, and may extend into the first pipe 110 along the first pipe 110 through the inner space of the enlarged pipe portion 120.

The refrigerant flowing inside the third pipe 140 is in a high-temperature state compared with the refrigerant passing through the first pipe 110, the enlarged pipe portion 120, and the second pipe 130, and may supply energy to the refrigerant flowing between the third pipe 140 and the enlarged portion 120 and between the third pipe 140 and the first pipe 110. This may improve the operating efficiency of the cooling cycle as described above.

The direction of the refrigerant flowing from the first pipe 110 to the second pipe 130 may be opposite to the direction of the refrigerant flowing through the third pipe 140. This may maximize the heat exchange efficiency and may induce improvement of the operating efficiency of the cooling cycle.

The noise reduction-type double-pipe heat exchanger 100 according to an embodiment of the present disclosure may improve the operating efficiency of the cooling cycle through the above operation. However, when a fluid flows at a specific velocity inside a pipe having a predetermined size, pulsation noise having a specific wavelength may occur.

Therefore, the noise reduction-type double-pipe heat exchanger 100 according to an embodiment of the present disclosure may have an enlarged pipe portion 120 arranged between the first pipe 110 and the second pipe 130 as illustrated in FIG. 3 so as to change the size of the pipe extending from the first pipe 110 to the second pipe 130 and to induce a change in the velocity of the fluid flowing therein, thereby suppressing occurrence of pulsation noise.

In addition, generation of a sound in a wavelength capable of counterbalancing the pulsation noise may be induced by changing the pipe size and the fluid velocity, and noise generation may be blocked through the counterbalance between the same.

As a method for generating noise that can counterbalance the pulsation noise, the present disclosure may, as illustrated in FIG. 3, change the method of connection between the second pipe 130 and the enlarged pipe portion 120 so as to counterbalance the pulsation noise.

To be specific, the second pipe 130 may be connected to the enlarged pipe portion 120 in such a manner that a part of the second pipe 130 is inserted into the enlarged pipe portion 120 and overlapped therewith. The frequency generated by the fluid flowing inside the first pipe 110, the enlarged pipe portion 120, and the second pipe 130 may be changed according to the depth a of insertion of the second pipe 130 into the enlarged pipe portion 120, and the pulsation noise may be counterbalanced by adjusting the same.

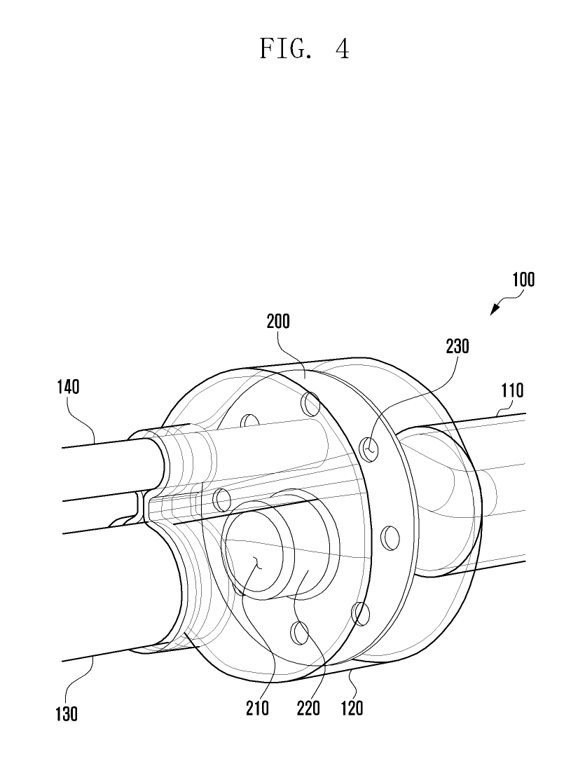

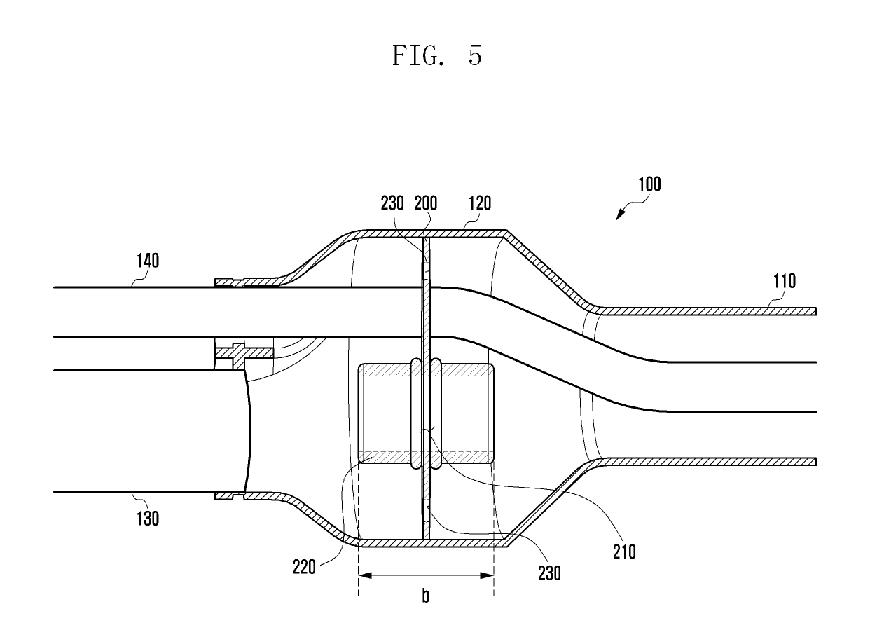

FIG. 4 is a perspective view illustrating the internal structure of a noise reduction-type double-pipe heat exchanger 100 according to another embodiment of the present disclosure. FIG. 5 is a sectional view illustrating the internal structure of the noise reduction-type double-pipe heat exchanger 100 according to another embodiment of the present disclosure.

FIG. 4 illustrates a structure for generating a frequency that can counterbalance pulsation noise in a manner different from that of the embodiment illustrated in FIG. 2 and FIG. 3.

Referring to FIG. 5, the noise reduction-type double-pipe heat exchanger 100 according to another embodiment of the present disclosure may include, inside an enlarged pipe portion 120, a barrier 200, a first through-hole 210, a second through-hole 230, and a fourth pipe 220.

The barrier 200 may be formed to bifurcate the enlarged pipe portion 120 in such a direction that the same blocks the flow of the refrigerant flowing from the first pipe 110 to the second pipe 130, and may have a first through-hole 210 formed therein such that the refrigerant can be circulated. The first through-hole 210 may be arranged such that the center thereof deviates from the virtual straight line connecting the first pipe 110 and the second pipe 130, thereby deforming the refrigerant flow path and accordingly suppressing the occurrence of pulsation noise.

The fourth pipe 220 may be inserted into the first through-hole 210, and the fourth pipe 220 may have an outer diameter corresponding to the diameter of the first through-hole 210 to be inserted therein. The fourth pipe 220 may change the diameter of the pipe through which the refrigerant flows, may change the refrigerant flow path, and may suppress occurrence of pulsation noise. In addition, it is possible to generate a wavelength of sound capable of counterbalancing the pulsation noise by adjusting the length b of the inserted fourth pipe 220.

The barrier 200 may have a plurality of second through-holes 230 formed therein to be smaller than the first through-hole 210. This may further diversify the flow path of the refrigerant flowing from the first pipe 110 to the second pipe 130, may diversify the flow velocity of the refrigerant, and may suppress occurrence of pulsation noise. In addition, it is possible to generate a wavelength of sound capable of counterbalancing the pulsation noise by diversifying the diameter of the second through-holes 230.

Although the present disclosure has been illustrated and described in connection with specific embodiments, it would be obvious to a person skilled in the art that the present disclosure may be variously improved and modified without departing from the scope of the technical idea of the present disclosure defined by the accompanying claims.

What is claimed is:

1. A noise reduction-type double-pipe heat exchanger comprising:
a first pipe through which a low-temperature fluid flows;
an enlarged pipe portion connected to the first pipe, the diameter of the enlarged pipe portion being larger than the diameter of the first pipe;
a second pipe connected to the enlarged pipe portion, the low-temperature fluid flowing through the second pipe; and
a third pipe formed separately from the first pipe and the second pipe, a high-temperature fluid flowing through the third pipe, the diameter of the third pipe being smaller than the diameter of the first pipe, the third pipe penetrating a surface of the enlarged pipe portion and extending into the first pipe through an inner portion of the enlarged pipe portion.

2. The noise reduction-type double-pipe heat exchanger of claim 1, further comprising a barrier provided inside the enlarged pipe portion and formed to block a flow of the low-temperature fluid, a first through-hole being formed in the barrier such that the low-temperature fluid can pass.

3. The noise reduction-type double-pipe heat exchanger of claim 2, further comprising a fourth pipe formed to have an outer diameter corresponding to the diameter of the first through-hole and inserted into the first through-hole.

4. The noise reduction-type double-pipe heat exchanger of claim 2, wherein the first through-hole has a center deviating from a virtual straight line connecting the first pipe and the second pipe.

5. The noise reduction-type double-pipe heat exchanger of claim 1, wherein the first pipe and the second pipe have central axes deviating from each other, respectively.

6. The noise reduction-type double-pipe heat exchanger of claim 2, wherein the barrier has a plurality of second through-holes formed to have a diameter smaller than the diameter of the first through-hole.

7. The noise reduction-type double-pipe heat exchanger of claim 1, wherein an identical fluid flows through the first pipe, the second pipe, and the third pipe, a low-temperature gas flows through the first pipe, and a high-temperature liquid flows through the third pipe.

8. The noise reduction-type double-pipe heat exchanger of claim 1, wherein the direction of the fluid flowing from the first pipe to the second pipe is opposite to the direction of the fluid flowing through the third pipe.

9. The noise reduction-type double-pipe heat exchanger of claim 1, wherein the second pipe is connected to the enlarged pipe portion such that a part of the second pipe is inserted into and overlapped with the enlarged pipe portion.

10. The noise reduction-type double-pipe heat exchanger of claim 1, wherein the fluid flowing through the first pipe, the second pipe, and the third pipe is an identical refrigerant circulating through a compressor, a condenser, an expansion valve, and an evaporator core.

11. The noise reduction-type double-pipe heat exchanger of claim 10, wherein the first pipe connects the evaporator core and the enlarged pipe portion, the second pipe connects the enlarged pipe portion and the compressor, and the third pipe connects the condenser and the expansion valve.
